(19) United States
(12) Patent Application Publication
(10) Pub. No.: US 2017/0215533 A1
(43) Pub. Date: Aug. 3, 2017

(54) Heart-Shaped Locket with Audio Device

(71) Applicant: Kyrima Davis, Loganville, GA (US)

(72) Inventor: Kyrima Davis, Loganville, GA (US)

(21) Appl. No.: 15/014,240

(22) Filed: Feb. 3, 2016

(51) Int. Cl. A44C 25/00; H04R 1/02

(52) U.S. Cl. CPC A44C 25/004; H04R 1/028; H04R 1/023

(57) ABSTRACT

Certain embodiments herein relate to a heart-shaped locket with audio device that comprises a front member that is connected to a rear member via a hinge. The front member may comprise a cavity configured to hold contents, where an interior side of the front member is a transparent cover that extends over the cavity to keep the contents within the cavity and allow a user to view the content in the cavity when the heart-shaped locket is in the open position. An interior side of the rear member may comprise a surface that may display an engraved message. An audio device may be disposed within the rear member that comprises an output device and a user control, where the user control activates the audio device to output a message via the output device, and where the user control may be disposed on an exterior side of the rear member.

### FIELD OF THE DISCLOSURE

Embodiments of the disclosure generally relate to a heart-shaped locket with audio device, and more particularly, to a heart-shaped locket with the ability to hold contents having sentimental value as well as the ability to play a recorded message.

### BACKGROUND

Often times, mementos or keepsakes, such as lockets, are often given as gifts to allow survivors to recall the memories of loved ones who are no longer with us. However, lockets are typically only personalized with a picture or an engraving.

### SUMMARY

Some or all of the above needs and/or problems may be addressed by certain embodiments of the disclosure. According to one embodiment of the disclosure, there is disclosed a heart-shaped locket with audio device. The heart-shaped locket may comprise a front member that is hingedly attached to a rear member. In certain embodiments, when the heart-shaped locket is in the closed position, a user may view an exterior side of the front member, which may be decorated in any preferred aesthetic manner When the heart-shaped locket is open, the user may then view an interior side of the front member. In one embodiment, the front member may comprise a cavity configured to hold contents within the front member. The contents may include, for example, cremation remains, hair, or other items of sentimental value. In one embodiment, the interior side of the front member may be a transparent cover that extends over the cavity to keep the contents contained within the cavity. Accordingly, when the user opens the heart-shaped locket and views the interior side of the front member, the user may view the contents contained within the cavity.

Additionally, when the heart-shaped locket is in the open position, the user may view an interior side of the rear member. In one embodiment, the interior side of the rear member may be a flat surface, which may be engraved with a message. An audio device may be disposed within the rear member of the heart-shaped locket. The audio device may include various components that combine to provide an electronic circuit for the playing of a recorded message. In certain embodiments, the audio device may be configured to output a recorded message via an output device, such as a speaker, when the user presses the user control, such as a button, which activates the audio device to play the recorded message. In one embodiment, the user control may be disposed on the exterior side of the rear member, such that the user may press the user control on the back of the rear member to hear the recorded message.

In certain embodiments, the heart-shaped locket with audio device may be worn as a necklace or a bracelet. Accordingly, when the user wishes to look at contents associated with a loved one or hear a message recorded by a loved one, the user may open the heart-shaped locket to view the contents in the front member and hear the recorded message output by the audio device by pressing the user control contained on the exterior side of the rear member.

Other embodiments, aspects, and features of the disclosure will become apparent to those skilled in the art from the following detailed description, the accompanying drawings, and the appended claims.

### BRIEF DESCRIPTION OF THE DRAWINGS

The detailed description is set forth with reference to the accompanying drawings, which are not necessarily drawn to scale. The use of the same reference numbers in different figures indicates similar or identical items.

FIG. 1 illustrates a front side view of a heart-shaped locket with audio device, according to an embodiment of the disclosure.

FIG. 2 illustrates a heart-shaped locket with audio device in the open position, according to an embodiment of the disclosure.

FIG. 3 illustrates a back view of a heart-shaped locket with audio device, according to an embodiment of the disclosure.

### DETAILED DESCRIPTION

Illustrative embodiments of the disclosure will now be described more fully hereinafter with reference to the accompanying drawings, in which some, but not all embodiments of the disclosure are shown. The disclosure may be embodied in many different forms and should not be construed as limited to the embodiments set forth herein; rather, these embodiments are provided so that this disclosure will satisfy applicable legal requirements.

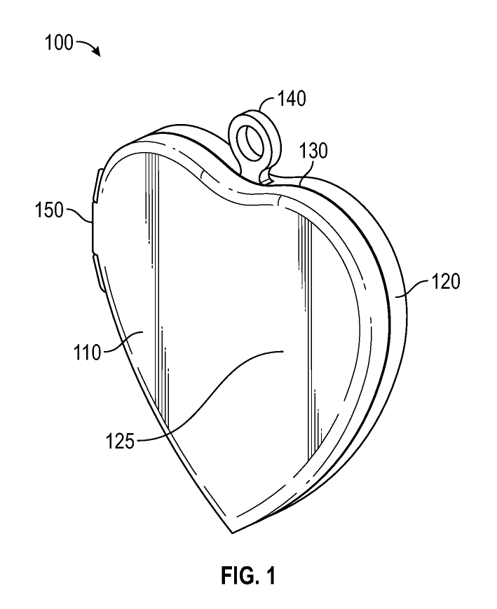

Referring now to FIG. 1, shown is a front side view of a heart-shaped locket with audio device according to an embodiment of the disclosure. As shown in FIG. 1, the heart-shaped locket with audio device 100 may comprise a front member 110 and a rear member 120. In certain embodiments, the front member 110 and the rear member 120 of the heart-shaped locket with audio device 100 are similarly heart-shaped, and each may comprise substantially half of the structure of the heart-shaped locket with audio device 100.

Still referring to FIG. 1, the front member 110 comprises an exterior side 125, which may be decorated in any preferred aesthetic manner In certain embodiments, the front member 110 and the rear member 120 of the heart-shaped locket with audio device 100 are made of, for example, any type of metal, including for example, metal, silver, gold, platinum, and the like.

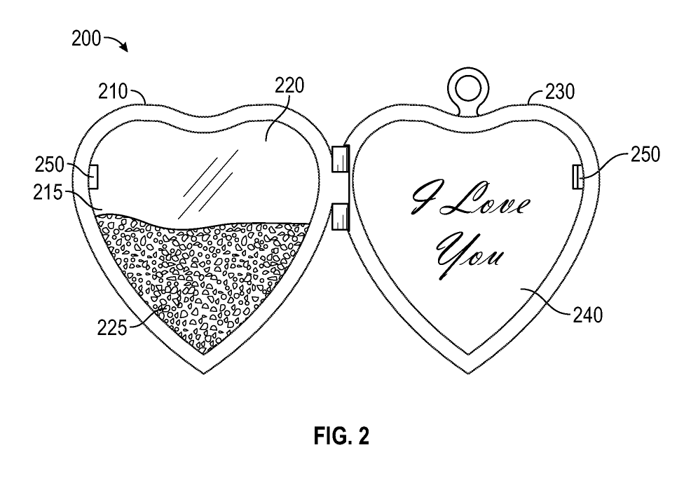

With continued reference to FIG. 1, the front member 110 and the rear member 120 may be attached via a hinge 150. The hinge 150 may comprise any known hinge or known similar device that provides for the inter-connection and hinged relationship between the front member 110 and the rear member 120. In certain embodiments, the hinge 150 allows for the front member to be placed in a closed position (as shown in FIG. 1) or an open position (as shown in FIG. 2).

Still referring to FIG. 1, in certain embodiment, a chain ring 140 may be disposed on an upper part 130 of the rear member 120. As shown in FIG. 1, the chain ring 140 may comprise an aperture configured to receive a chain, band, strap, string, thread or the like. Accordingly, a user may wear the heart-shaped locket with audio device 100 as a necklace or bracelet.

Referring now to FIG. 2, shown is the heart-shaped locket with audio device in the open position, according to an embodiment of the disclosure. As shown in FIG. 2, the heart-shaped locket with audio device 200 is opened, a user may view an interior side 215 of the front member 210 as well as an interior side 240 of the rear member 230. In certain embodiments, the front member 210 comprises a depth to form a cavity 220 in which contents 225 may be placed inside. For example, as shown in FIG. 2, the contents 225 may comprise cremation ashes, which are deposited and stored within the cavity 220. In one embodiment, the interior side 215 of the front member 210 is a transparent cover that extends over the cavity 220 to prevent the loss of the contents 225 and to allow a user to view the contents 225 within the cavity 220. The contents 225 may include other items besides cremation ashes, such as, for example, human or pet hair, or other items that may be of sentimental value.

With continued reference to FIG. 2, the interior side 240 of the rear member 230 may be a substantially flat surface that may be engraved with a message. For instance, as shown in FIG. 2, the interior side 240 of the rear member 230 may be engraved with “I love you” which is displayed to the user when looking at the interior side 240 of the rear member 230.

Still referring to FIG. 2, in certain embodiments, the interior side 215 of the front member 210 and the interior side 240 of the rear member 230 may include latching members 250. In certain embodiments, latching members 250 may be any suitable clasping mechanism known in the art for securing the front member 210 to the rear member 230 when the heart-shaped locket with audio device 200 is in the closed position.

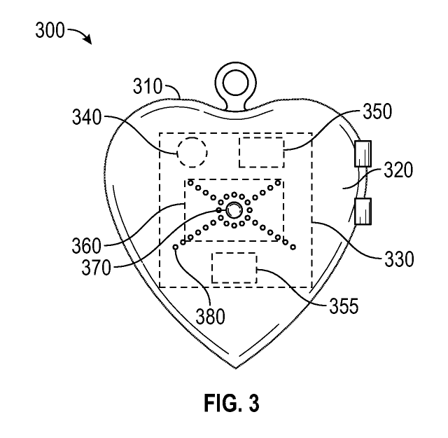

Referring now to FIG. 3, shown is a back view of the heart-shaped locket with audio device according to an embodiment of the disclosure. As shown in FIG. 3, the heart-shaped locket with audio device 300 may comprise a rear member 310 having an exterior side 320. In certain embodiments, rear member 310 comprises a depth that allows an audio device 330 to be placed inside the rear member 310. That is, between the interior side (such as interior side 240 in FIG. 2) of the rear member 310 and the exterior side 320 of the rear member 310 is a “compartment,” in which the audio device 330 may be placed. In certain embodiments, audio device 330 may comprise a device that provides voice and/or sound recording and playback functions. In one embodiment, the audio device 330 may be configured so that it may record and playback one or more messages.

Still referring to FIG. 3, in certain embodiments, the audio device 330 may comprise a power source 340, a controller 350, an input device 355, an output device 360, and a user control 370. In operation, the various components of audio device 330 combine to provide an electronic circuit for the playing and recording of messages. The power source 340 may be any suitable power source that is known in the art, which may be used for powering the audio device 330. For instance, the power source 340 may comprise a battery, a solar cell, and the like. In certain embodiments, the power source 340 may be disposed in the rear member 310 of the heart-shaped locket 300 such that it may be easily accessible to a user to permit the user to replace and/or recharge the power source 340.

The controller 350 may comprise any known processor known in the art which controls the playing and/or recording of one or more message. In certain embodiments, the controller 350 may be configured to store one or more recordings stored in a memory location and then playback a recording or message in response to a user pressing the user control 370. In certain embodiments, the user control 370 may be a button, which may be perform different functions, such as play, record, delete, and the like. As shown in FIG. 3, the user control 370 may be disposed on the exterior side 320 of the rear member 310 of the heart-shaped locket with audio device 300. As such, a user may press the user control 370 to hear a recorded message when the heart-shaped locket with audio device 300 is in the closed position.

Still referring to FIG. 3, the input device 355 of the audio device 330 may comprise, for example, a microphone, or any other suitable device configured to capture information, such as a message that a user would like to record. The output device 360 of the audio device 330 may comprise, for instance, a speaker, or other device, through which the recorded message is played and output. As shown in FIG. 3, in certain embodiments, the exterior side 320 of the rear member 310 may comprise one or more holes 380 to form a speaker grill. That is, the output device 360, such as a speaker, may be disposed beneath holes 380, thereby allowing sound to travel from the speaker in order to allow a user to hear the recorded message.

Definitions

The following definitions are included to provide a clear and consistent understanding of the specification and claims. As used herein, the recited terms have the following meanings. All other terms and phrases used in this specification have their ordinary meanings as one of skill in the art would understand.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrase “one or more” is readily understood by one of skill in the art, particularly when read in context of its usage.

As used herein, the term “about” refers to an approximately +/−10% variation from a given value. It is to be understood that such a variation is always included in any given value provided herein, whether or not it is specifically referred to.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The claimed invention is:

1. A heart-shaped locket, comprising:
a front member comprising a cavity and an interior side, wherein the cavity is configured to hold contents within the front member, and wherein the interior side of the front member is a transparent cover that extends over the cavity to keep the content within the cavity and to allow a user to view the contents within the cavity when the heart-shaped locket is in the open position;
a rear member comprising an interior side and an exterior side, wherein the interior side of the rear member is a surface configured to display an engraved message that is visible to the user when the heart-shaped locket is in the open position, and wherein the rear member is attached to the front member via a hinge that hingedly connects the front member to the rear member;
an audio device comprising an output device and a user control, wherein the audio device is disposed within the rear member, and wherein the user control activates the audio device to output one or more messages via the output device, and wherein the user control is disposed on the exterior side of the rear member.

2. The heart-shaped locket of claim 1, wherein the audio device further comprises a processor, a power source for powering the audio device, an input device for recording the one or more messages, and wherein the output device is disposed directly behind the exterior side of the rear member.

3. The heart-shaped locket of claim 1, wherein the contents comprise cremation remains, hair, or other items of sentimental value.

4. The heart-shaped locket of clam 1, wherein the front member and the rear member comprises metal, silver, gold, platinum, and the like.

5. The heart-shaped locket of claim 1, wherein the exterior side of the rear member comprises one or more holes to form a speaker grill, wherein the output device of the audio device is disposed behind the one or more holes in order to allow the user to hear the one or more messages from the output device.

6. The heart-shaped locket of claim 1, wherein the rear member further comprises a chain ring disposed on an upper part of the rear member, and wherein the chain ring comprises an aperture configured to receive a chain to allow the user to wear the heart-shaped locket as a necklace or bracelet.
